(19) United States
(12) Patent Application Publication
(10) Pub. No.: US 2015/0136922 A1
(43) Pub. Date: May 21, 2015

(54) SUCTION SYSTEM WITH REVERSIBLE DOME SPRING

(71) Applicant: Sulumbek Shamsadov, Brooklyn, NY (US)

(72) Inventor: Sulumbek Shamsadov, Brooklyn, NY (US)

(21) Appl. No.: 14/550,539

(22) Filed: Nov. 21, 2014

Related U.S. Application Data
(60) Provisional application No. 61/907,217, filed on Nov. 21, 2013.

(51) Int. Cl. F16B 47/00

(52) U.S. Cl. CPC F16B 47/00
USPC 248/206.2; 29/451

(57) ABSTRACT

A suction system includes a sucker having a working face and a dome spring attached to the sucker. The dome spring has a convex dome position and a concave dome position relative to the sucker and is configured such that, when the top of the dome spring is pushed inward past a critical moment, the dome spring reverses position without any further application of external force. The dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring.

This application claims the benefit of U.S. Provisional Application No. 61/907,217, filed Nov. 21, 2013, which is hereby incorporated by reference in its entirety.

### FIELD OF THE INVENTION

The present invention relates generally to suction systems and more particularly to mechanical overpressure suction systems.

### BACKGROUND

Existing suction systems include suction cups and the like. A suction cup, also called a sucker, uses negative fluid pressure to adhere to nonporous surfaces and in the process creates a partial vacuum. The working face of a suction cup has a curved (spherical) surface. When the center of the suction cup is pressed against a flat, non-porous surface, the volume of space between the suction cup and the flat surface is reduced, which causes the fluid between the cup and the surface to be expelled past the rim of the circular working face. When the user ceases to apply physical pressure to the center of the outside of the cup, the elastic cup tends to resume its original, curved shape. Because most of the fluid has already been forced out of the inside of the cup, the cavity which tends to develop between the cup and the flat surface has little to no fluid in it, resulting in a low pressure within the cavity. The pressure difference between the atmosphere on the outside of the cup, and the low-pressure cavity on the inside of the cup, is what keeps the cup adhered to the surface.

The length of time for which the suction effect can be maintained depends on the magnitude of the starting pressure difference and on how long it takes for fluid to leak back into the cavity between the cup and the surface, equalizing the pressure with the surrounding atmosphere. This depends on the porosity and flatness of the surface and the rim of the cup.

Such suction devices suffer from low adhesion strength and loss of adhesion strength over time and under adverse conditions. Detaching such devices can also be difficult where there is adequate adhesion strength, due to a difficulty in creating a gap between the suction cup and the surface in order to release the vacuum pressure. Needs exist for improved suction systems offering improved and longer-lasting adhesion and ease of attachment and detachment.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

A new suction system in embodiments combines metal and rubber parts. The system generates a high-pressure vacuum to attach together two different parts. The system allows for easy attachment and detachment between two surfaces.

A new suction system secures a dome spring to a sucker to provide easy attachment and detachment and very strong adhesion. The dome spring is attached to the sucker and positioned in a way that flexing it between a convex and concave position reduces or expands the area between the sucker and a surface, creating a strong negative pressure (vacuum) or releasing it.

A new suction system may include a sucker having a working face and a dome spring attached to the sucker. The dome spring has a convex dome position and a concave dome position relative to the sucker and is configured such that, when the top of the dome spring is pushed inward past a critical moment, the dome spring reverses position without any further application of external force. The dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring.

The sucker and dome spring may be configured such that pressing the sucker against a surface causes the sucker to exert a force against the dome spring in a direction perpendicular to the surface.

The suction system may also include a base securing the sucker to the dome spring. The base and sucker may be configured such that pressing the base toward a surface while the working face of the sucker is touching the surface presses the working face of the sucker against the surface without exerting any direct force on the center of the dome spring in the direction of the surface. The base may be attached to an object intended to be removably secured to surfaces, for example a grip ring. A side of the dome spring opposite the sucker may be accessible to a user for removal of the suction system from the surface, for example by leaving an opening between the object and the dome spring where a user can insert a finger. Alternatively the opening may only be large enough for insertion of some tool such as a screwdriver, paperclip, etc. A side of the dome spring opposite the sucker may be not directly accessible to a user, and the suction system may further include a trigger mechanism configured to exert force on the side of the dome spring opposite the sucker to release the suction system from the surface. For example, the base may be attached to another surface, and there may be no way for a user to insert a finger or object between the base and that surface, however there may be an electronically or mechanically triggered spring or other force projector on that surface where the base is attached, allowing a user to, for example, push a button and release the spring to exert force against the dome spring and push it past the critical moment. Another button or other mechanism may retract/withdraw the force projecting element back into the other surface (or other object) for re-use.

The base may be part of an object intended to be removably secured to surfaces. For example the base may be built into a surface of the object, such that the sucker protrudes directly from that surface. The dome spring may extend through to the other side of that surface, where it can be manipulated, or may be manipulated for example using an internal mechanism.

The base may include a clip sandwiching the base, spring dome and sucker. The base and dome spring may be metal and the sucker rubber. The sucker may for example be a silicone rubber material or another material useful for suction cups or other suction systems. The dome spring may be any flexible metal or plastic having a spherical curve and the property of springing between convex and concave positions when pushed past a critical moment. The base and clip may be metal, plastic, glass, wood, etc. in various embodiments as long jas they have sufficient strength and rigidity for the application. The base may have a central apron and an outer ring and a channel between the central apron and outer ring, and the sucker may have a contact surface surrounding the apron, where the contact surface is compressed between the apron and the clip and outer ring. The contact surface and edge of the dome spring may be sandwiched adjacent one another between the apron and the clip. The sucker, dome spring, clip and base may have round cross-sections.

The sucker may have a bumper between the working face and the dome spring that pushes against the dome spring when the working face of the sucker is pressed against the surface.

The suction system may include a base having an outer ring having a circular cross-section and a top horizontal surface, an inner apron having a circular cross section, and a connecting portion between the outer ring and inner apron and having a circular cross-section, where the outer ring, inner apron, and connecting portion together form a channel and a central through-hole extends through the base and is defined by the interior circumference of the apron. The suction system may also include a clip comprising a clip outer ring and a projection extending radially and longitudinally inward from an end of the clip outer ring, forming a niche between the clip outer ring and projection, where the clip outer ring is inserted in the channel of the base, between the outer ring of the base and the contact surface of the sucker, thereby compressing the contact surface of the sucker between the clip outer ring and the base apron, and where the clip projection pins the edge of the dome spring against the contact surface of the sucker, which is also compressed between the edge of the dome spring and the base apron. The sucker may have membranes, a lip around the circumference of the membranes extending in a first direction, a bumper on the membranes extending in a second direction perpendicular to the membranes, and a contact surface extending from the lip and forming a groove, where the apron of the base is inserted snugly into the groove. The dome spring may have an edge and a spherical top, where the dome spring is on one side directly adjacent to the bumper of the sucker and the contact surface of the sucker opposite the groove. When the dome spring is in the convex position with respect to the sucker, pressing the sucker against a surface by pressing on the top horizontal surface of the base may cause the sucker bumper to press the spherical top of the dome spring inward.

A new suction attachment method may include pressing a sucker against a surface, where the sucker comprises a working face and is attached to a dome spring, where the dome spring has a convex dome position and a concave dome position relative to the sucker and is configured such that, when the top of the dome spring is pushed inward past a critical moment, the dome spring reverses position without any further application of external force, where the dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring, pushing the dome spring inward past a critical moment, and reversing the position of the dome spring from the convex dome position to the concave dome position, expanding a volume between the dome spring and the surface and creating a negative pressure in the volume.

A new suction detachment method may include pressing a dome spring inward past a critical moment, where the dome spring is attached to a sucker comprising a working face and adhered to a surface, where the dome spring has a convex dome position and a concave dome position relative to the sucker and is configured such that, when the top of the dome spring is pushed inward past a critical moment, the dome spring reverses position without any further application of external force, where the dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring, and reversing the position of the dome spring from the concave dome position to the convex dome position, reducing a volume between the dome spring and the surface and increasing a pressure in the volume and releasing the sucker from the surface.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a plan view of a suction system with reversible dome spring, in an embodiment.

FIG. 2 is a bottom view of a suction system with reversible dome spring, in an embodiment.

FIG. 3 is a side view of a suction system with reversible dome spring, in an embodiment.

FIG. 4 is a section view of the base of a suction system with reversible dome spring, in an embodiment.

FIG. 5 is a bottom view of the base of a suction system with reversible dome spring, in an embodiment.

FIG. 6 is a plan view of the base of a suction system with reversible dome spring, in an embodiment.

FIG. 7 is a plan view of the sucker of a suction system with reversible dome spring, in an embodiment.

FIG. 8 is a bottom view of the sucker of a suction system with reversible dome spring, in an embodiment.

FIG. 9 is a section view of the sucker of a suction system with reversible dome spring, in an embodiment.

FIG. 10 is a plan view of the clip of a suction system with reversible dome spring, in an embodiment.

FIG. 11 is a bottom view of the clip of a suction system with reversible dome spring, in an embodiment.

FIG. 12 is section view of the clip of a suction system with reversible dome spring, in an embodiment.

FIG. 13 is a bottom view of the dome spring of a suction system with reversible dome spring, in an embodiment.

FIG. 14 is a section view of the dome spring of a suction system with reversible dome spring, in an embodiment.

FIG. 15 is a section view of an assembled suction system with reversible dome spring detached from a surface, in an embodiment.

FIG. 16 is a section view of an assembled suction system with reversible dome spring attached to a surface, in an embodiment.

REFERENCE NUMERALS IN THE DRAWINGS

```
  10 - base
  12 - chamfer
  12a - bottom horizontal surface
  12b - top horizontal surface
  14 - channel
  16 - apron
218 - inside diameter
  18a - outside diameter
  18b - edge of trough hole
  20 - clip
  22 - limiter
  22a - top edge
  22b - eased corner
  24 - niche
  24a - conic surface
  24b - middle edge
  26 - bottom edge
  28 - internally diameter
  28a - externally diameter
  30 - reversible dome spring
  32 - edge
  34 - spherical surface
  40 - sucker
  42 - lip
  44 - groove
  44a - contact surface
  46 - bumper
  48 - membranes
```

### DETAILED DESCRIPTION

A suction system with reversible dome spring will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

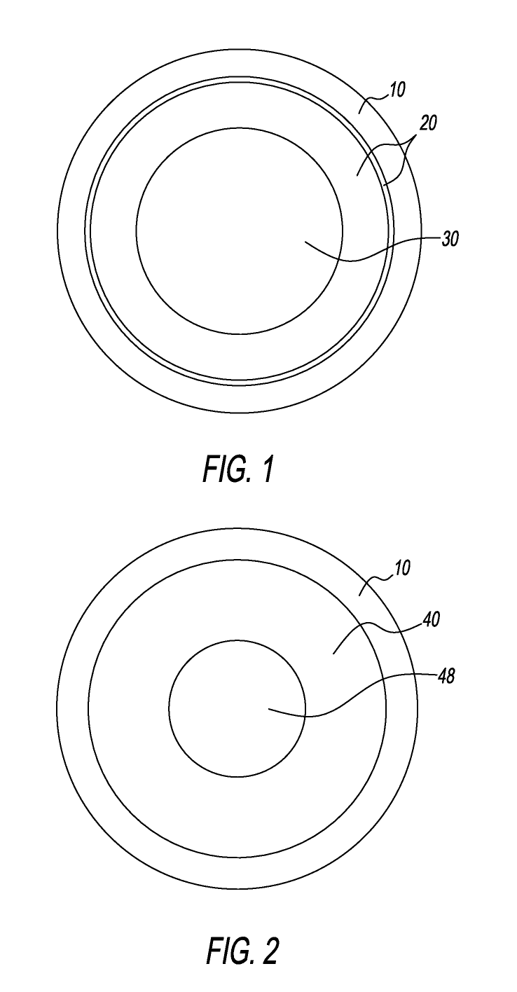

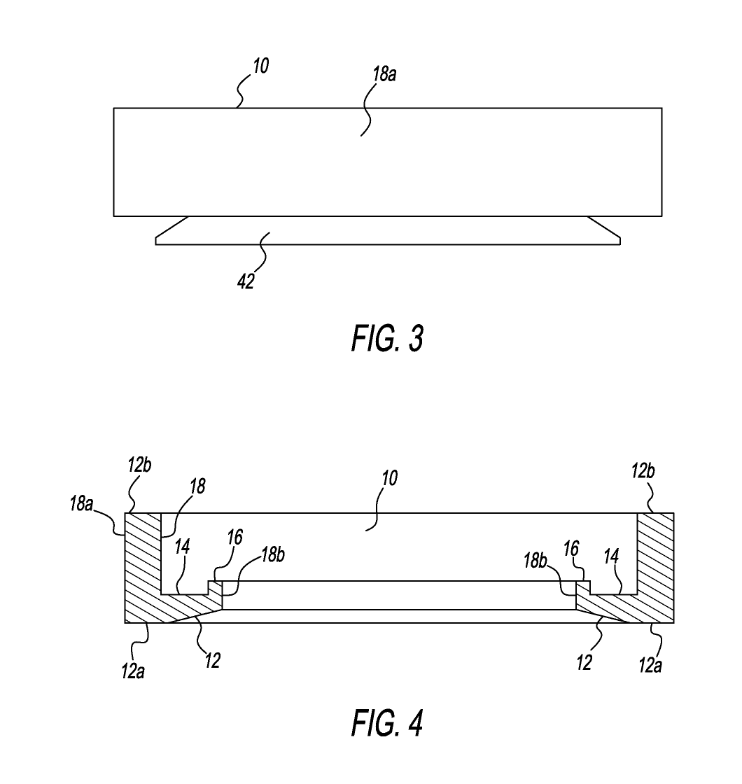

FIG. 1 is a plan view of a suction system showing reversible dome spring 30 laying under clip 20 and the clip 20 pressed into the base 10. The dome spring 30 may be a rigid material in a dome shape that can be snapped between convex and a concave dome positions. FIG. 2 is a bottom view of the suction system showing sucker 40 attached to the base 10. FIG. 3 is a side view of the system showing lip 42 of sucker 40 attached to the base 10, and outside diameter 18a of the base 10.

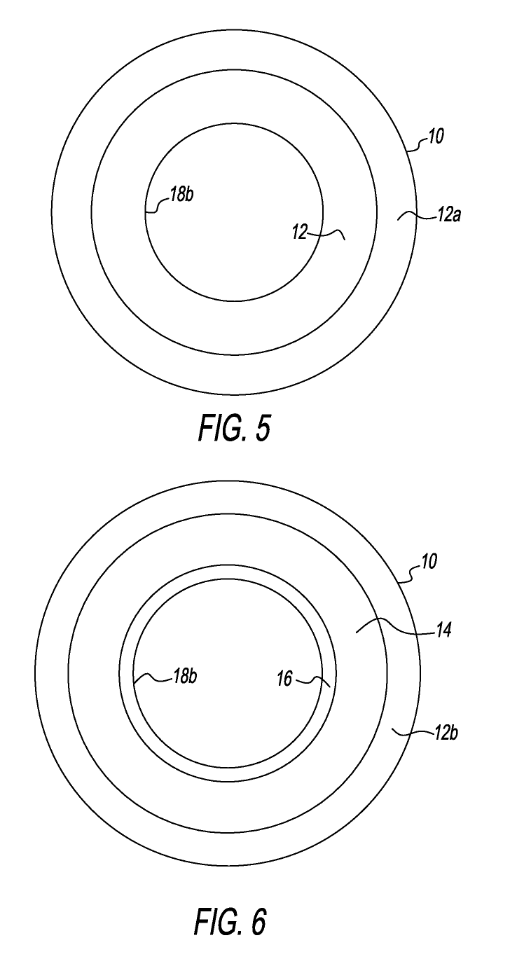

FIG. 4 shows a section view of the base 10 including chamfer 12, bottom horizontal surface 12a, top horizontal surface 12b, channel 14, apron 16, inside diameter 18, outside diameter 18a and through-hole edge 18b. FIG. 5 is a bottom view of the base 10 showing the chamfer 12, bottom horizontal surface 12a and the through-hole edge 18b. FIG. 6 is a plan view of the base 10 showing the channel 14 and apron 16, top horizontal surface 12b and the through-hole edge 18b.

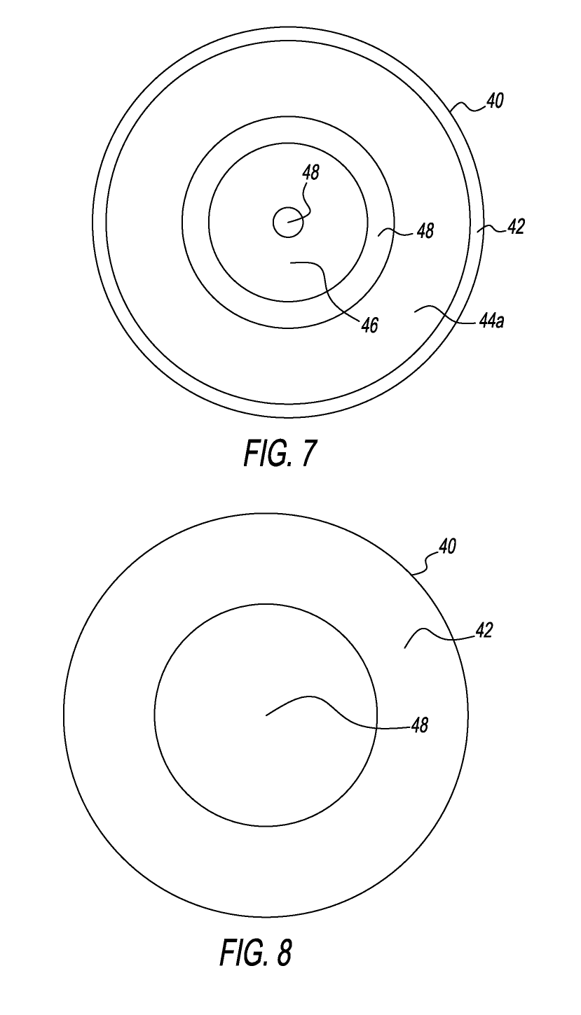

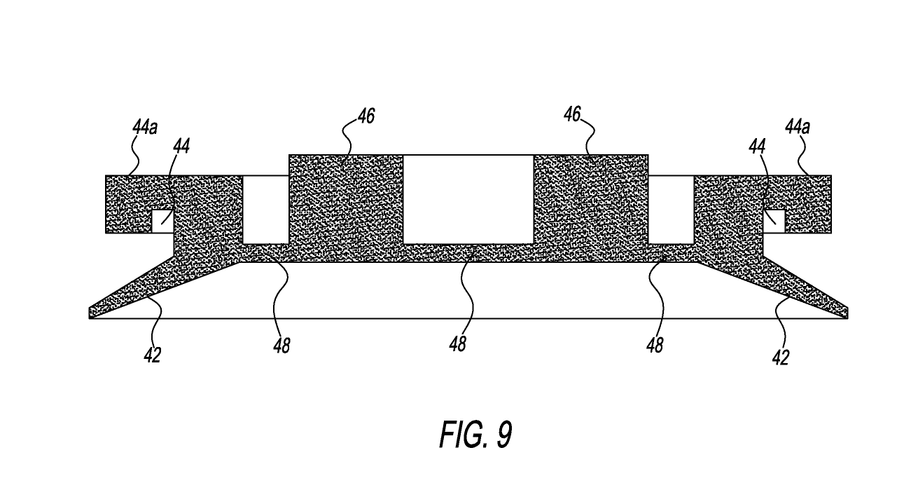

FIG. 7 is a plan view of the sucker 40 with lip 42, contact surface 44a, bumper 46 and membranes 48. FIG. 8 is a bottom view of the sucker 40 showing lip 42 and membranes 48. FIG. 9 is a section view of the sucker 40 with lip 42, groove 44, contact surface 44a, bumper 46 and membranes 48.

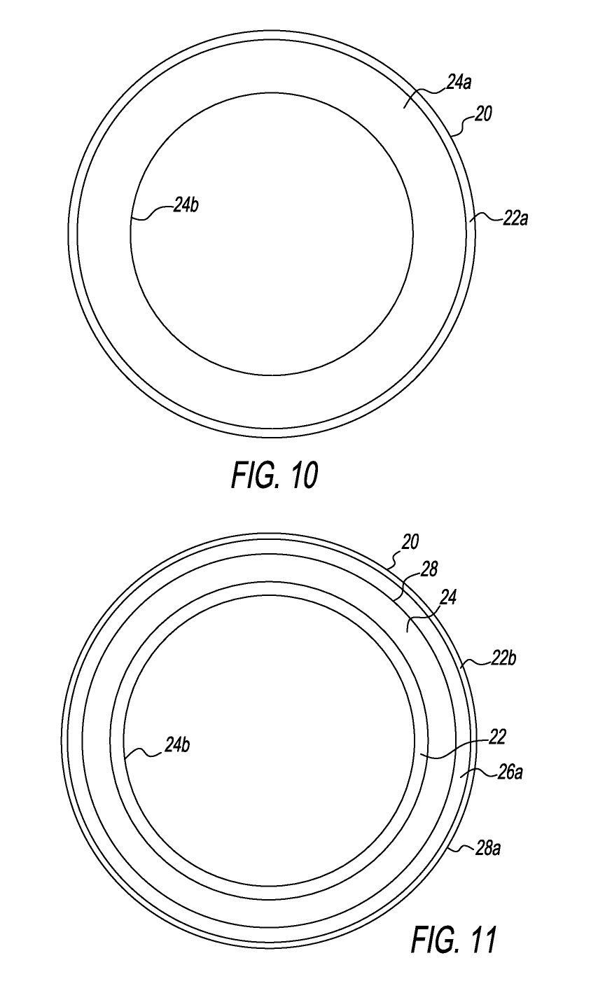

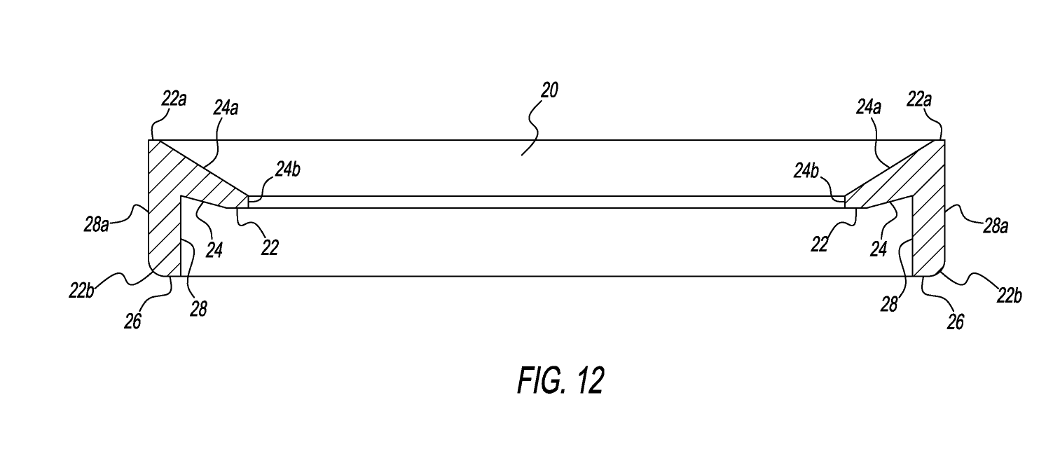

FIG. 10 is a plan view of the clip 20 showing top edge 22a, conic surface 24a, and middle edge 24b. FIG. 11 is a bottom view of the clip 20 showing limiter 22, eased corner 22b, niche 24, middle edge 24b, bottom edge 26a, internal diameter 28 and external diameter 28a. FIG. 12 is a section view of the clip 20 showing the limiter 22, top edge 22a, eased corner 22b, niche 24, conic surface 24a, middle edge 24b, bottom edge 26, internal diameter 28 and external diameter 28a.

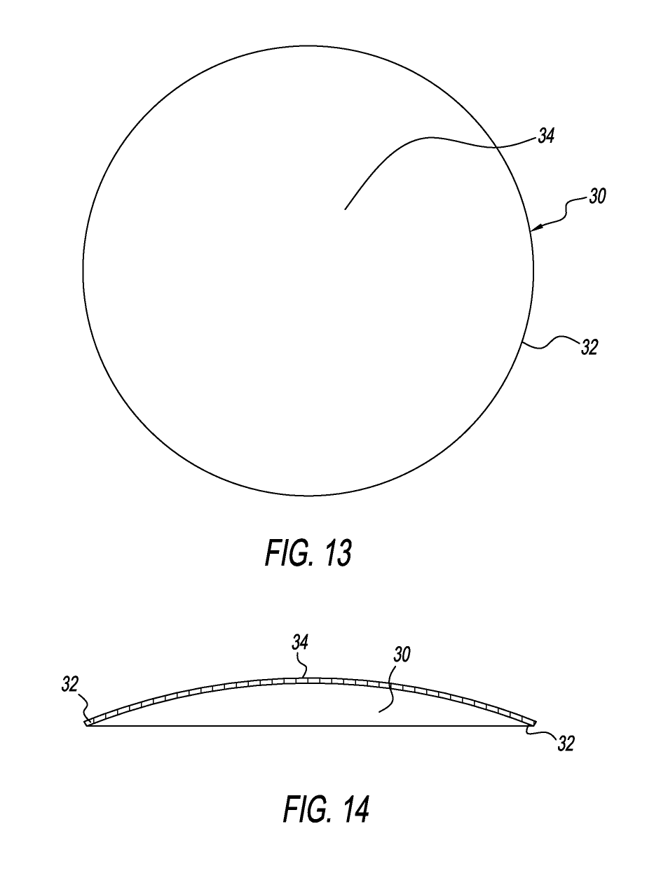

FIG. 13 is a bottom view of the dome spring 30 with spherical top 34 and edge 32. The plan view thereof is identical. FIG. 14 is a section view of the dome spring 30 with edges 32 and spherical top surface 34.

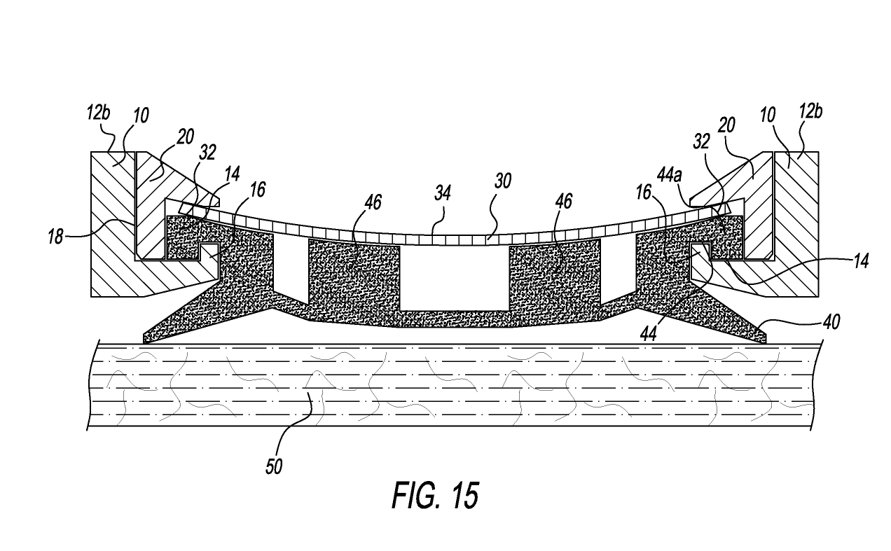

FIG. 15 shows a section view of an assembled suction system resting on but detached from a surface 50. The sucker 40 is secured in channel 14 of the base 10 by contact surface 44a , which surrounds apron 16 of the base 10 inside groove 44. Edge 32 of the dome spring 30 lays above the contact surface 44a. Sucker 40 and dome spring 30 are fixed in this position by clip 20, which is pressed into the base 10 through the inside diameter 18 of the base 10. The channel 14 of the base 10, clip 20 and contact surface 44a of sucker 40 are sized such that sandwiching them in the manner shown squeezes them tightly together and secures them in place. The contact surface 44a of sucker 40 is here an elastic material that is compressed between the surfaces of the clip 20 and apron 16 of the base 10 to create a tight seal. Likewise, dome spring 30 is sandwiched tightly between clip 20 and working face 44a of sucker 40 and apron 16 of base 10. The resulting compressive forces are sufficient to maintain the various parts (clip 20, sucker 40, dome spring 30, base 10) in place. In other embodiments, for example for use in extreme conditions, there may be additional securing elements, for example a rivet or screw may be inserted though the base 10, clip 20, and sucker 40 to secure them together.

To attach to the surface 50, the device is pushed down using the top horizontal surface 12b. When a user pushes the top horizontal surface 12b of the base 10 towards the surface 50, the bumpers 46 of the sucker 40 push against the inside of the spherical surface 34 of the dome spring 30 in a direction away from the surface 50, causing the spherical surface 34 of the dome spring 30 to flex away from the surface 50. When the critical moment passes, the dome spring 30 changes position and becomes biased in the reverse direction, away from the surface 50.

As the rim 42 of sucker 40 is pressed tight against the surface 50 by the force exerted by the user on top surface 12b of the base 10, an airtight seal exists between the sucker 40 and surface 50 at the time of the dome spring 30 position change. When the dome spring 30 passes the critical moment and becomes biased away from the surface 50, popping out away from the surface 50, it creates additional volume between the sucker 40 and surface 50. However, as there is an airtight seal between the sucker 40 and surface 50 created by the force exerted by the user against top surface 12b, no new air from outside the suction system can enter this area and the same mass of air must now fill the expanded volume, creating a strong negative pressure that adheres the sucker 40 (and therefore the entire suction device) to surface 50. The resulting attachment between the surface 50 and suction system is extremely strong, far stronger than the adhesion force created by a typical suction cup.

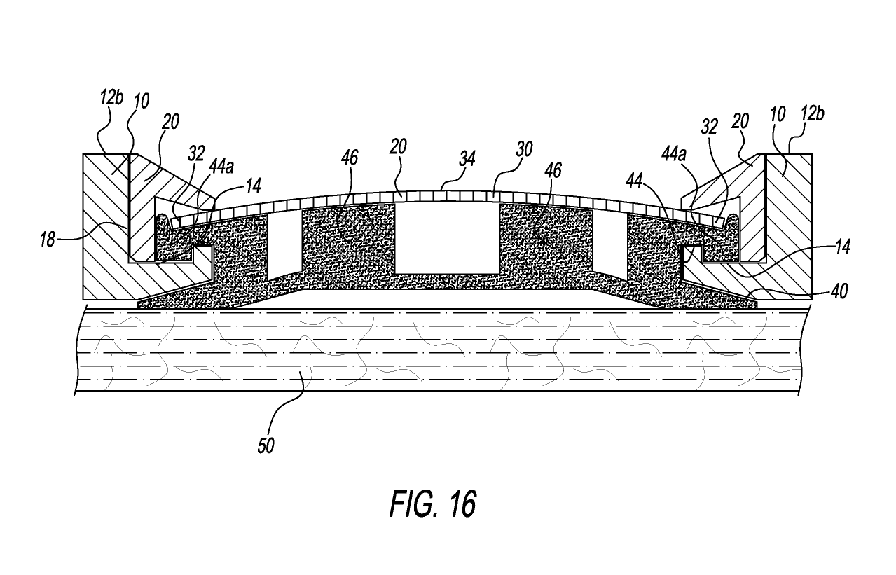

FIG. 16 is a section view of an assembled suction system attached to the surface 50. The sucker 40 again is secured in channel 14 of the base 10 by contact surface 44a, which surrounds apron 16 of the base 10 inside groove 44. Edge 32 of the dome spring 30 lays above the contact surface 44a. Sucker 40 and dome spring 30 are fixed in this position by clip 20, which is pressed into the base 10 through the inside diameter 18 of the base 10.

To detach the suction system from the surface 50, the center of the spherical surface 34 of the dome spring 30 is pushed towards the surface 50. When pushed past the critical moment, the dome spring 30 changes position and becomes biased in the reverse direction, towards the surface 50 (i.e. popping inward). This reduces the volume, therefore increasing the pressure, under the sucker 40, releasing the sucker 40 from the surface 50.

The invention is not limited to the particular embodiments illustrated in the drawings and described above in detail. Those skilled in the art will recognize that other arrangements could be devised, for example, many different structural configurations are possible for the suction system, as long as the relationship between the dome spring and sucker is maintained. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the invention has been described with reference to specific illustrative embodiments, modifications and variations of the invention may be constructed without departing from the spirit and scope of the invention as set forth in the following claims.

I claim:

1. A suction system, comprising:
a sucker comprising a working face; and
a dome spring attached to the sucker;
wherein the dome spring has a convex dome position and a concave dome position relative to the sucker and is configured such that, when the top of the dome spring is pushed inward past a critical moment, the dome spring reverses position without any further application of external force;
wherein the dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring.

2. The suction system of claim 1, wherein the sucker and dome spring are configured such that pressing the sucker against a surface causes the sucker to exert a force against the dome spring in a direction perpendicular to the surface.

3. The suction system of claim 1, further comprising a base securing the sucker to the dome spring.

4. The suction system of claim 3, wherein the base and sucker are configured such that pressing the base toward a surface while the working face of the sucker is touching the surface presses the working face of the sucker against the surface without exerting any direct force on the center of the dome spring in the direction of the surface.

5. The suction system of claim 4, wherein the base is attached to an object intended to be removably secured to surfaces.

6. The suction system of claim 5, wherein a side of the dome spring opposite the sucker is accessible to a user for removal of the suction system from the surface.

7. The suction system of claim 5, wherein a side of the dome spring opposite the sucker is not directly accessible to a user, further comprising a trigger mechanism configured to exert force on the side of the dome spring opposite the sucker to release the suction system from the surface.

8. The suction system of claim 4, wherein the base is part of an object intended to be removably secured to surfaces.

9. The suction system of claim 3, wherein the base comprises a clip sandwiching the base, spring dome and sucker.

10. The suction system of claim 9, wherein the base and dome spring are metal and the sucker is rubber.

11. The suction system of claim 9, wherein the base comprises a central apron and an outer ring and a channel between the central apron and outer ring, and the sucker comprises a contact surface surrounding the apron, wherein the contact surface is compressed between the apron and the clip and outer ring.

12. The suction system of claim 11, wherein the contact surface and edge of the dome spring are sandwiched adjacent one another between the apron and the clip.

13. The suction system of claim 9, wherein the sucker, dome spring, clip and base have round cross-sections.

14. The suction system of claim 2, wherein the sucker comprises a bumper between the working face and the dome spring that pushes against the dome spring when the working face of the sucker is pressed against the surface.

15. The suction system of claim 1, further comprising:
a base comprising an outer ring having a circular cross-section and a top horizontal surface, an inner apron having a circular cross section, and a connecting portion between the outer ring and inner apron and having a circular cross-section, wherein the outer ring, inner apron, and connecting portion together form a channel and a central through-hole extends through the base and is defined by the interior circumference of the apron; and
a clip comprising a clip outer ring and a projection extending radially and longitudinally inward from an end of the clip outer ring, forming a niche between the clip outer ring and projection, wherein the clip outer ring is inserted in the channel of the base, between the outer ring of the base and the contact surface of the sucker, thereby compressing the contact surface of the sucker between the clip outer ring and the base apron, and wherein the clip projection pins the edge of the dome spring against the contact surface of the sucker, which is also compressed between the edge of the dome spring and the base apron;
wherein the sucker comprises membranes, a lip around the circumference of the membranes extending in a first direction, a bumper on the membranes extending in a second direction perpendicular to the membranes, and a contact surface extending from the lip and forming a groove, wherein the apron of the base is inserted snugly into the groove;
wherein the dome spring comprises an edge and a spherical top, wherein the dome spring is on one side directly adjacent to the bumper of the sucker and the contact surface of the sucker opposite the groove;
wherein when the dome spring is in the convex position with respect to the sucker, pressing the sucker against a surface by pressing on the top horizontal surface of the base causes the sucker bumper to press the spherical top of the dome spring inward.

16. A suction attachment method, comprising:
pressing a sucker against a surface, wherein the sucker comprises a working face and is attached to a dome spring, wherein the dome spring has a convex dome position and a concave dome position relative to the sucker and is configured such that, when the top of the dome spring is pushed inward past a critical moment, the dome spring reverses position without any further application of external force, wherein the dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring;
pushing the dome spring inward past a critical moment; and
reversing the position of the dome spring from the convex dome position to the concave dome position, expanding a volume between the dome spring and the surface and creating a negative pressure in the volume.

17. A suction detachment method, comprising:
pressing a dome spring inward past a critical moment, wherein the dome spring is attached to a sucker comprising a working face and adhered to a surface, wherein the dome spring has a convex dome position and a concave dome position relative to the sucker and is configured such that, when the top of the dome spring is pushed inward past a critical moment, the dome spring reverses position without any further application of external force, wherein the dome spring is attached to the sucker such that a change in position of the dome spring from the concave dome position to the convex dome position pushes the working face of the sucker in a direction away from the dome spring and a change in position of the dome spring from the convex dome position to the concave dome position allows the working face of the sucker to move in a direction towards the dome spring; and
reversing the position of the dome spring from the concave dome position to the convex dome position, reducing a volume between the dome spring and the surface and increasing a pressure in the volume and releasing the sucker from the surface.
